(19) United States
(12) Patent Application Publication
(10) Pub. No.: US 2026/0093102 A1
(43) Pub. Date: Apr. 2, 2026

(54) QUAD-VIEW IMAGE SPLITTER FOR MULTICOLOR FLUORESCENCE MICROSCOPY

(71) Applicant: BOARD OF REGENTS, THE UNIVERSITY OF TEXAS SYSTEM, Austin, TX (US)

(72) Inventor: Daniel J. DICKINSON, Austin, TX (US)

(21) Appl. No.: 19/113,172

(22) PCT Filed: Sep. 21, 2023
(86) PCT No.: PCT/US2023/033356

§ 371 Date: Mar. 19, 2025

Related U.S. Application Data
(60) Provisional application No. 63/376,516, filed on Sep. 21, 2022.

(51) Int. Cl. G02B 21/36; G02B 5/08; G02B 5/10; G02B 21/08; G02B 21/16

(52) U.S. Cl. CPC G02B 21/36; G02B 5/0825; G02B 5/10; G02B 21/08; G02B 21/16

(57) ABSTRACT

An example imaging component can include: a light dispersing element or light dispersing portion that is configured to split an incident light beam into a plurality of secondary light beams, wherein each of the plurality of secondary light beams is associated with a particular wavelength; a plurality of lenses that are each configured to collimate and direct one of the plurality of secondary light beams along a respective optical path within the imaging component; and a recombining element or recombining portion comprising a plurality of pickoff mirrors that is configured to: (i) recombine the plurality of secondary light beams into a recombined light beam, and (ii) direct the recombined light beam to an image sensor.

### CROSS-REFERENCE TO RELATED APPLICATIONS

This Application claims the benefit of U.S. provisional Ser. No. 63/376,516 filed on Sep. 21, 2022, and titled “QUAD-VIEW IMAGE SPLITTER FOR MULTICOLOR FLUORESCENCE MICROSCOPY,” the contents of which are expressly incorporated herein by reference in their entirety.

### STATEMENT REGARDING FEDERALLY FUNDED RESEARCH

This invention was made with government support under Grant numbers R00 GM115964 and R01 GM138443 awarded by the National Institutes of Health. The government has certain rights in the invention.

### BACKGROUND

Imaging devices may be used to capture images of biological specimen, including, for example, living cells. Many imaging devices are plagued by technical challenges and limitations. For example, imaging devices are technically challenging and expensive to produce, and many perform sub-optimally in multi-color fluorescence applications.

Scientific Complementary Metal-Oxide-Semiconductor (sCMOS) cameras may be used in a variety of scientific instruments and imaging systems including microscopes and telescopes. For example, biologists may label living cells using fluorescent dyes which emit light at specific wavelengths and capture images of the cells. By way of example, an image of a living cell may show different cell components (e.g., 2 to 4 different cell components) simultaneously by labelling particular structures and molecules with different fluorescent dyes that emit light at different wavelengths. Conventionally, optical filters may be used in a sequential fashion to isolate specific wavelengths, in order to observe the behavior of certain structures within a cell. For example, components or structures of a cell may be labelled with a blue-fluorescent dye, a green-fluorescent dye, and a red-fluorescent dye. In this example, a blue light filter that is configured to select the blue light can be operatively coupled to a camera and used to capture a first image. Then, a green light filter that is configured to select the green light can be operatively coupled to the camera and used to capture a second image, and so on. However, when observing living, non-static cells, the above process may lead to different fluorescent channels being offset from one another in time which can create a motion blurring effect in the final image output.

### SUMMARY

Various embodiments described herein relate to methods, apparatuses, and systems for providing an apparatus, such as, for example, an imaging component of an imaging apparatus.

An example imaging component can comprise: a light dispersing element or light dispersing portion that is configured to split an incident light beam into a plurality of secondary light beams, wherein each of the plurality of secondary light beams is associated with a particular wavelength; a plurality of lenses that are each configured to collimate and direct one of the plurality of secondary light beams along a respective optical path within the imaging component; and a recombining element or recombining portion, the recombining element or recombining portion including a plurality of pickoff mirrors that is configured to: (i) recombine the plurality of secondary light beams into a recombined light beam, and (ii) direct the recombined light beam to an image sensor.

In some implementations, each optical path contains a first lens to collimate a respective one of the plurality of secondary light beams and a second lens to refocus the respective one of the plurality of secondary light beams on the image sensor.

In some implementations, the recombining element or recombining portion is configured to direct each of the plurality of secondary light beams onto a different region on a surface of the image sensor.

In some implementations, the plurality of secondary light beams includes four secondary light beams, eight secondary light beams, or sixteen secondary light beams.

In some implementations, the light dispersing element or light dispersing portion includes a plurality of dichroic mirrors.

In some implementations, each of the plurality of dichroic mirrors is positioned at an angle between 0 degrees and 45 degrees relative to a horizontal surface of the imaging component.

In some implementations, at least one of the plurality of dichroic mirrors is positioned at a 14 degree angle relative to a horizontal surface of the imaging component.

In some implementations, each of the plurality of dichroic mirrors is fixedly or removeable mounted on or attached to a substrate defining a bottom surface of the imaging component.

In some implementations, the plurality of dichroic mirrors includes a first dichroic mirror, a second dichroic mirror, and a third dichroic mirror.

In some implementations, the first dichroic mirror and the second dichroic mirror are arranged along a first axis and the first dichroic mirror and the third dichroic mirror are arranged along a second axis, the first axis being perpendicular to the second axis.

In some implementations, the first axis and the second axis are arranged at an angle that is determined by a respective angle of each of the plurality of dichroic mirrors.

In some implementations, a first optical axis of the first dichroic mirror and a second optical axis of the second dichroic mirror are perpendicular.

In some implementations, the techniques described herein relate to an imaging component, wherein the light dispersing element or light dispersing portion is configured to split the incident light beam such that each of the plurality of secondary light beams encounter only two of the plurality of dichroic mirrors along its respective optical path.

In some implementations, the plurality of pickoff mirrors includes a first pickoff mirror, a second pickoff mirror, and a third pickoff mirror.

In some implementations, the first pickoff mirror is mounted at a first angle, and the second pickoff mirror and third pickoff mirror are mounted at a second angle that is 90 degrees from the first angle.

In some implementations, the plurality of secondary light beams includes a first secondary light beam, a second secondary light beam, a third secondary light beam, and a fourth secondary light beam.

In some implementations, the first pickoff mirror and the second pickoff mirror are arranged to reflect the first secondary light beam onto a first region on a surface of the image sensor.

In some implementations, the first pickoff mirror is arranged to reflect the second secondary light beam onto a second region on a surface of the image sensor.

In some implementations, the second pickoff mirror is arranged such that the second secondary light beam passes above or beneath it.

In some implementations, the third pickoff mirror is arranged to reflect the third secondary light beam onto a third region on a surface of the image sensor.

In some implementations, the first pickoff mirror is arranged such that the third secondary light beam passes beside it.

In some implementations, the first pickoff mirror and the third pickoff mirror are arranged such that the fourth secondary light beam pass beside and above or beneath them, respectively, and onto a fourth region on a surface of the image sensor.

In some implementations, each pickoff mirror includes a semi-circular D-shaped mirror.

In some implementations, the imaging component is operatively coupled to a fluorescence microscope or confocal microscope.

In some implementations, the imaging component is mounted adjacent an emission port of the fluorescence microscope or confocal microscope.

In some implementations, the image sensor includes a complementary metal-oxide-semiconductor image sensor or electron multiplying charge couple detector.

An example multi-color imaging system can include: a first modular imaging component; and a second modular imaging component operatively coupled to the first modular imaging component, wherein each of the first modular imaging component and the second modular imaging component includes: a light dispersing element or light dispersing portion that is configured to split an incident light beam into a plurality of secondary light beams, wherein each of the plurality of light beams is associated with a particular wavelength, a plurality of lenses that are each configured to collimate and direct one of the plurality of secondary light beams along a respective optical path within the respective modular imaging component, and a recombining element or recombining portion, the recombining element or recombining portion including a plurality of pickoff mirrors that is configured to: (i) recombine the plurality of secondary light beams into a recombined light beam, and (ii) direct the recombined light beam to an image sensor.

In some implementations, a bottom surface of the second modular imaging component is positioned adjacent a top surface of the first modular imaging component.

An example multi-color imaging system can include: a first modular imaging component; a second modular imaging component; and a third modular imaging component, wherein: each of the first modular imaging component, the second modular imaging component, and the third modular imaging component are operatively coupled to one another, and each of the first modular imaging component, the second modular imaging component, and the third modular imaging component includes: a light dispersing element or light dispersing portion that is configured to split an incident light beam into a plurality of secondary light beams, wherein each of the plurality of secondary light beams is associated with a particular wavelength, a plurality of lenses that are each configured to collimate and direct one of the plurality of secondary light beams along a respective optical path of the respective modular imaging component, and a recombining element or recombining portion, the recombining element or recombining portion including a plurality of half shaped mirrors that is configured to: (i) recombine the plurality of secondary light beams into a recombined light beam, and (ii) direct the recombined light beam unto a surface of an image sensor.

In some implementations, a method for capturing multi-color images using an imaging component is provided. The imaging component can include a light dispersing element or light dispersing portion, a plurality of lenses, and a recombining element or recombining portion including a plurality of pickoff mirrors, the method including: receiving a light beam via an aperture of the imaging component; splitting, using the light dispersing element or light dispersing portion, the light beam into a plurality of secondary light beams, wherein each of the plurality of secondary light beams is associated with a particular wavelength; collimating and directing, using the plurality of lenses, each of the plurality of secondary light beams along a respective optical path within the imaging component; recombining, using the recombining element or recombining portion, the plurality of secondary light beams into a recombined light beam; and directing the recombined light beam to an image sensor.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an example view of an imaging component according to implementations described herein.

FIG. 2 illustrates another example view of an imaging component according to implementations described herein.

FIG. 3 illustrates another example view of an imaging component according to implementations described herein.

FIG. 4 illustrates an example view of a recombining element according to implementations described herein.

FIG. 5 illustrates an example view of a portion of a recombining element according to implementations described herein.

FIG. 6 illustrates an example view of a multi-color imaging system according to implementations described herein.

FIG. 7 illustrates an example view of an imaging component according to implementations described herein.

FIG. 8 is an example view of an imaging component according to implementations described herein.

FIG. 9 is an example perspective view of a recombining portion of an imaging apparatus according to implementations described herein.

FIG. 10 is a top view of an imaging component according to implementations described herein.

FIG. 11 is an example perspective view of a recombining portion of an imaging component according to implementations described herein.

FIG. 12 is a block diagram that illustrates an example computing device according to implementations described herein.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. This disclosure contemplates that the imaging components and methods described herein can be used in a variety of applications, including fluorescence microscopy, confocal microscopy, electron multiplying charge couple detection, and/or the like. The imaging components and methods can be used to generate multicolor images using a single image sensor.

With the advent of large-sensor sCMOS cameras for biological microscopy, there is an opportunity to simultaneously capture multi-color images on a single camera sensor by splitting light emitted from a fluorescence microscope according to wavelength and assigning each wavelength a unique location on the camera sensor. In some examples, an optical dichroic mirror may be utilized to split a light beam (e.g., microscope emission line) into shorter and longer wavelengths that can be recombined and arranged side-by-side on two halves of a camera sensor. Accordingly, images can be captured simultaneously (e.g., a first half of an example camera sensor may be used to capture an image associated with blue light and a second half of the example camera sensor may be used to capture an image associated with green light) in order to eliminate motion artifacts. Subsequently, image processing techniques can be used to combine or overlay the images and produce a final image output. However, this approach becomes less effective as the number of wavelengths, channels, and/or colors increases. In particular, as the number of wavelengths, channels, and/or colors increases, a light beam may be directed through many elements (e.g., optical glass) where each encounter introduces image distortions. For example, each light beam in a two-wavelength imaging system may encounter four mirrors, and each light beam in a four-wavelength system may encounter six mirrors. Said differently, the number of mirrors required increases with the number of wavelengths, thereby degrading the performance of these systems. Additionally, these systems may require a large number of expensive elements (e.g., dichroic mirrors) making these devices costly, technically complex to produce, and impractical for capturing four or more colors.

There is a need for imaging systems that maximize imaging speed, sensitivity, quality, that can be made inexpensively for various applications. Embodiments of the present disclosure provide an imaging component that facilitates imaging of four or more colors simultaneously on a single camera sensor. In some embodiments, the imaging component is configured to be mounted at an emission port of an imaging apparatus (e.g., fluorescence microscope). In some embodiments, an arrangement of mirrors (e.g., three dichroic mirrors) split an incident light beam provided by the imaging apparatus (e.g., fluorescence microscope) into a plurality of secondary light beams (e.g., four secondary light beams that are each associated with a particular wavelength). In some embodiments, the imaging component comprises a plurality of lenses (e.g., relay lenses) that are each configured to collimate and direct one of the plurality of secondary light beams along a respective optical path within the imaging component. In some embodiments, the imaging component comprises a recombining element comprising a plurality of pickoff mirrors (e.g., D-shaped half-mirrors) that is configured to recombine the plurality of secondary light beams into a recombined light beam and direct the recombined light beam to an image sensor of the imaging apparatus. The term recombining element may refer to a subcomponent of an imaging component that can include a housing or frame configured to house or contain a plurality of mirrors or optical elements. Following an initial alignment and configuration, the imaging component can operate in a passive manner, splitting images that it receives without any user intervention or moving parts.

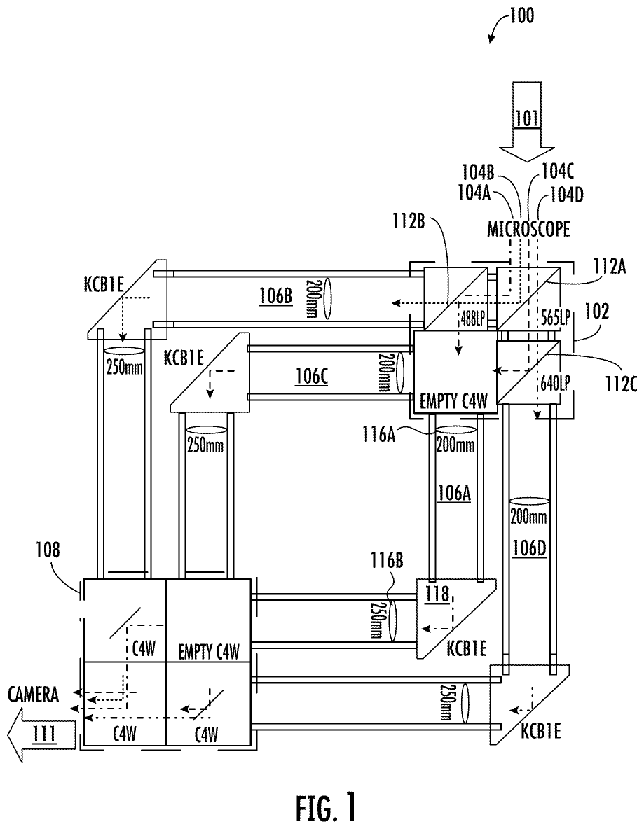

Referring now to FIG. 1, an example top view of an imaging component 100 is shown. In particular, as depicted, the imaging component 100 comprises a light dispersing element 102 and a recombining element 108. In some embodiments, the imaging component 100 comprises a body with a substantially cuboid shape. The imaging component 100 may be at least partially disposed within a housing (e.g., metal, plastic, combinations thereof, and/or the like). The imaging component 100 may be configured to be mounted at an emission port of an imaging apparatus, such as, but not limited to, a fluorescence microscope, confocal microscope, telescope, electron multiplying charge couple detector (EMCCD), or the like. As depicted in FIG. 1, a light beam 101 may enter an aperture on a surface of the imaging component 100. The light beam 101 may be provided (e.g., generated) by an imaging apparatus (e.g., fluorescence microscope, confocal microscope, or the like) that is operatively coupled to the imaging component 100. Additionally, the imaging component 100 defines a plurality of optical paths (e.g., channels). For example, the imaging component 100 comprises a first optical path 106A, beginning with an aperture on a surface of the imaging component 100/light dispersing element 102 through which a light beam can enter, pass through, and exit from the imaging component 100 at an exit point on another surface of the imaging component 100 (e.g., adjacent an image sensor). The term light dispersing element may refer to a subcomponent of an imaging component that can include a housing or frame configured to house or contain a plurality of mirrors or optical elements. It should be understood that the term optical path can refer to a predefined path taken by a light beam and may not be a physically distinct channel or path.

As shown in FIG. 1, the light beam 101 enters the aperture and is incident on (e.g., makes contact with) a light dispersing element 102. In the example shown in FIG. 1, the light dispersing element 102 is a substantially cuboid shape defining a first corner/edge of the imaging component 100. In various examples, the light dispersing element 102 is configured to split (e.g., divide) the incident light beam 101 into a plurality of secondary light beams that are each associated with a particular wavelength of light. The light dispersing element 102 may comprise a plurality of mirrors (e.g., as shown, a block or element comprising three dichroic mirrors) that is configured to split the incident light beam 101 into a plurality of secondary light beams. In particular, the light dispersing element 102 into a first secondary light beam 104A (e.g., blue light or radiant energy), a second secondary light beam 104B (e.g., green light or radiant energy), a third secondary light beam 104° C. (e.g., red light or radiant energy), and a fourth secondary light beam 104D (e.g., dark red light or radiant energy).

In the example shown in FIG. 1, the light dispersing element 102 comprises a first mirror 112A, a second mirror 112B, and a third mirror 112C. In some examples, each mirror 112A, 112B, and 112C may be or comprise a dichroic mirror. In some embodiments, as depicted in FIG. 1, the first mirror 112A and the second mirror 112B are arranged along a first axis of the light dispersing element 102, and the first mirror 112A and the third mirror 112C are arranged along a second axis of the light dispersing element 102, where the first axis is perpendicular to the second axis. As further depicted in FIG. 1, the light dispersing element 102 directs each secondary light beam 104A, 104B, 104C, and 104D along a respective optical path within the imaging component 100. In particular, the light dispersing element 102 is configured to direct the first secondary light beam 104A along a first optical path 106A, the secondary light beam 104B along a second optical path 106B, the third secondary light beam 104C along a third optical path 106C, and the fourth secondary light beam 104D along a fourth optical path 106D. For example, the light beam 101 may first make contact with the first mirror 112A which may be configured to separate shorter wavelength beams (e.g., less than 565 nm) from longer wavelength beams (e.g., greater than 565 nm). Subsequently, each of the second mirror 112B and the third mirror 112C may further divide or split an incident beam into further subsets. In some embodiments, the first mirror 112A comprises a dichroic mirror with a reflection edge at 565 nanometers (nm), the second mirror 112B comprises a dichroic mirror with a reflection edge at 488 nm, and the third mirror 112C comprises a dichroic mirror with a reflection edge at 640 nm. It should be understood that the choice of wavelengths can be varied to suit different applications.

Using the hierarchical configuration for the light dispersing element 102 described above and variations thereof, the number of mirrors required to divide or split beams into certain wavelengths scales as the square root of the number of wavelengths/channels. Said differently, the number of wavelengths can be increased in a multiplicative rather than an additive fashion. For example, three mirrors (e.g., dichroic mirrors) can be used to split an incident light beam into four different secondary light beams of different wavelengths. Similarly, four mirrors (e.g., dichroic mirrors) can be used to split an incident light beam into eight different secondary light beams of different wavelengths. In contrast, conventional systems which operate in an additive fashion may require seven mirrors to split an incident beam into eight wavelength beams. Additionally, each optical path in imaging component 100 encounters only two dichroic mirrors, compared to three or more in conventional systems. In an eight-wavelength splitter, each optical path would encounter only three dichroic mirrors, compared to seven in a conventional system. By reducing the number of encounters between each secondary light beam and various optical elements (particularly dichroic mirrors, but also including other lenses, mirrors, and the like), the example imaging component 100 is less susceptible to image distortion and can be used to provide high-quality images.

As illustrated in FIG. 1, each optical path 106A, 106B, 106C, and 106D defines a substantially cylindrical channel (e.g., with a 200 millimeter (mm) diameter) that is connected to a surface of the light dispersing element 102. Additionally, as shown, each optical path 106A, 106B, 106C, and 106D defines an L-shaped path (e.g., comprising two adjoining linear sections that are perpendicular to one another) disposed between the light dispersing element 102 and the recombining element 108 adjacent an exit aperture of the imaging component 100 (e.g., leading to an image sensor). Additionally, in some examples, each optical path comprises a reflective mirror that connects a first linear section to a second linear section. For example, as depicted in FIG. 1, a 45-degree reflective mirror 118 connects a first linear section of the first optical path 106A with a second linear section of the first optical path 106A. Similar or identical reflective mirrors may connect linear sections of each of the other optical paths 106B, 106C, and 106D. In the example shown in FIG. 1, the first optical path 106A and the third optical path 106C define inner channels of the imaging component 100, and the second optical path 106B and the fourth optical path 106D define outer channels of the imaging component 100. In various embodiments, each optical path 106A, 106B, 106C, and 106D comprises two or more lenses that are configured to collimate and direct a secondary light beam passing therethrough. For example, as shown, the first optical path 106A comprises a first lens 116A and a second lens 116B that is disposed downstream in relation to the first lens 116A. The first lens 116A and the second lens 116B may each comprise relay lenses. In some embodiments, the first lens 116A is configured to collimate the first secondary light beam 104A and the second lens 116B is configured to refocus the secondary light beam 104B as it traverses the optical path 106A. Similarly, each of the second optical 106B, the third optical path 106C, and the fourth optical path 106D may comprise two or more lenses (e.g., a collimating and a refocusing lens). In various embodiments, the focal lengths of each pair of lenses may be selected to introduce additional magnification or de-magnification. For example, as shown, each optical path 106A, 106B, 106C and 106D contains a collimating lens with focal length 200 mm and a refocusing lens with focal length 250 mm, which will produce a 1.25× magnification along each optical path.

As noted above, and as depicted in FIG. 1, the imaging component 100 comprises a recombining element 108. In various embodiments, the recombining element 108 is configured to recombine a plurality of secondary light beams (e.g., secondary light beams 104A, 104B, 104C, and 104D) into a recombined light beam 111 and direct the recombined light beam 111 to an image sensor (e.g., sCMOS camera, EMCCD, or the like) of an imaging apparatus (e.g., fluorescence microscope). In some embodiments, the recombining element 108 is configured to direct each of the plurality of secondary light beams (e.g., secondary light beams 104A, 104B, 104C, and 104D) onto a different region on a surface of an image sensor. In some examples, the recombining element 108 comprises a plurality of pickoff mirrors (e.g., D-shaped half mirrors, semi-circular half mirrors, knife-edge prism mirrors, and/or any other mirror with an edge). In some embodiments, the recombining element 108 comprises a first pickoff mirror, a second pickoff mirror, and a third pickoff mirror.

While FIG. 1 provides an example of an imaging component 100, it is noted that the scope of the present disclosure is not limited to the example shown in FIG. 1. In some examples, an imaging component may comprise one or more additional and/or alternative elements that may be structured and/or positioned differently than those in FIG. 1.

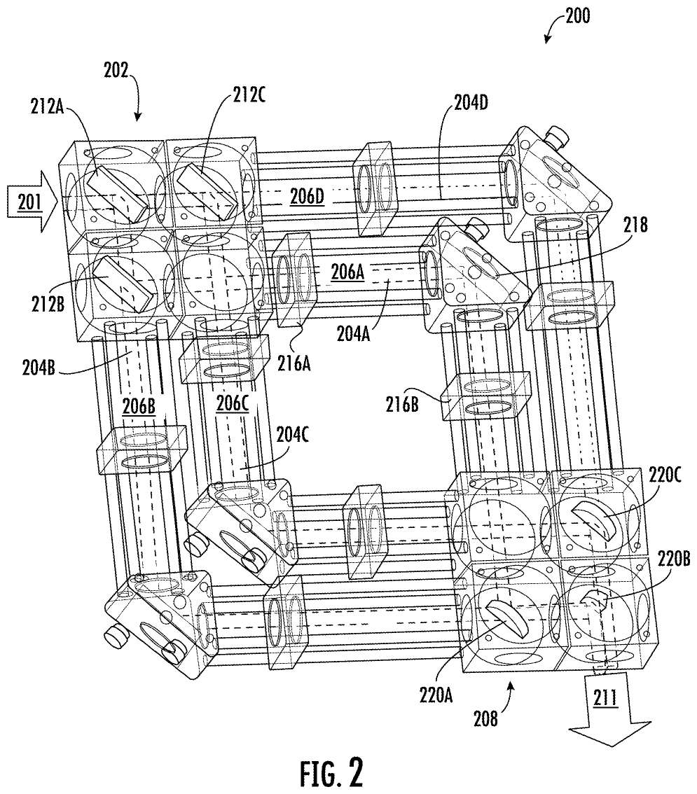

Referring now to FIG. 2, another example top view of an imaging component 200 is shown. In particular, as depicted, the imaging component 200 comprises a light dispersing element 202 and a recombining element 208. The imaging component 200 may be at least partially disposed within a housing and defines a body with a substantially cuboid shape. As depicted in FIG. 2, a light beam 201 may enter an aperture on a surface of the imaging component 200. The light beam 201 may be provided (e.g., generated) by an imaging apparatus (e.g., fluorescence microscope, confocal microscope, or the like) that is operatively coupled to the imaging component 200. Additionally, the imaging component 200 defines a plurality of optical paths. For example, the imaging component 200 comprises a first optical path 206A, beginning with an aperture on a surface of the imaging component 200/light dispersing element 202 through which a light beam can enter, pass through, and exit from the imaging component 200 at an exit point on another surface of the imaging component 200 (e.g., adjacent an image sensor).

As shown in FIG. 2, the light beam 201 enters the aperture and is incident on (e.g., makes contact with) a light dispersing element 202. In the example shown in FIG. 2, the light dispersing element 202 is a substantially cuboid shape defining a first corner/edge of the imaging component 200. In various examples, the light dispersing element 202 is configured to split (e.g., divide) the incident light beam 201 into a plurality of secondary light beams that are each associated with a particular wavelength of light. The light dispersing element 202 may comprise a plurality of mirrors (e.g., as shown, a block or element comprising three dichroic mirrors) that is configured to split the incident light beam 201 into a plurality of secondary lights beams. In particular, the light dispersing element 202 is configured to split the incident light beam 201 into a first secondary light beam 204A (e.g., blue light or radiant energy), a second secondary light beam 204B (e.g., green light or radiant energy), a third secondary light beam 204C (e.g., red light or radiant energy), and a fourth secondary light beam 204D (e.g., far red light or radiant energy).

In the example shown in FIG. 2, the light dispersing element 202 comprises a first mirror 212A, a second mirror 212B, and a third mirror 212C. In some examples, each mirror 212A, 212B, and 212C may be or comprise a dichroic mirror. In some examples, the first mirror 212A and the second mirror 212B are arranged along a first axis of the light dispersing element 202, and the first mirror 212A and the third mirror 212C are arranged along a second axis of the light dispersing element 202, where the first axis is perpendicular to the second axis. As further depicted in FIG. 2, the light dispersing element 202 directs each secondary light beam 204A, 204B, 204C, and 204D along a respective optical path within the imaging component 200. In particular, the light dispersing element 202 is configured to direct the first secondary light beam 204A along a first optical path 206A, the secondary light beam 204B along a second optical path 206B, the third secondary light beam 204C along a third optical path 206C, and the fourth secondary light beam 204D along a fourth optical path 206D. For example, the light beam 201 may first make contact with the first mirror 212A which may be configured to separate shorter wavelength beams from longer wavelength beams. Subsequently, each of the second mirror 212B and the third mirror 212C may further divide or split an incident beam into further subsets. In some embodiments, the first mirror 212A comprises a dichroic mirror with a reflection edge at 565 nanometers (nm), the second mirror 212B comprises a dichroic mirror with a reflection edge at 488 nm, and the third mirror 212C comprises a dichroic mirror with a reflection edge at 640 nm.

As illustrated in FIG. 2, each optical path 206A, 206B, 206C, and 206D defines a substantially cylindrical channel (e.g., with a 25 millimeter (mm) diameter) that is connected to a surface of the light dispersing element 202. Additionally, as shown, each optical path 206A, 206B, 206C, and 206D defines an L-shaped path (e.g., comprising two adjoining linear sections that are perpendicular to one another) disposed between the light dispersing element 202 and the recombining element 208 adjacent an exit aperture of the imaging component 200 (e.g., leading to an image sensor). Additionally, in some examples, each optical path comprises a reflective mirror that connects a first linear section to a second linear section. For example, as depicted in FIG. 2, a 45-degree reflective mirror 218 connects a first linear section of the first optical path 206A with a second linear section of the first optical path 206A. Similar or identical reflective mirrors may connect linear sections of each of the other optical paths 206B, 206C, and 206D. In the example shown in FIG. 2, the first optical path 206A and the third optical path 206C define inner channels of the imaging component 200, and the second optical path 206B and the fourth optical path 206D define outer channels of the imaging component 200. In various embodiments, each optical path 206A, 206B, 206C, and 206D comprises one or more lenses that are each configured to collimate and direct a secondary light beam passing therethrough. For example, as shown, the first optical path 206A comprises a first lens 216A and a second lens 216B that is disposed downstream in relation to the first lens 216A. The first lens 216A and the second lens 216B may each comprise relay lenses. In some embodiments, the first lens 216A is configured to collimate the first secondary light beam 204A and the second lens 216B is configured to refocus the secondary light beam 204B as it traverses the optical path 206A. Similarly, each of the second optical 206B, the third optical path 206C, and the fourth optical path 206D may comprise one or more lenses (e.g., a first lens and a second lens).

As noted above, and as depicted in FIG. 2, the imaging component 200 comprises a recombining element 208. In various embodiments, the recombining element 208 is configured to recombine a plurality of secondary light beams (e.g., secondary light beams 204A, 204B, 204C, and 204D) into a recombined light beam 211 and direct the recombined light beam 211 to an image sensor (e.g., sCMOS camera, EMCCD, or the like) of an imaging apparatus (e.g., fluorescence microscope). In some embodiments, the recombining element 208 is configured to direct each of the plurality of secondary light beams (e.g., secondary light beams 204A, 204B, 204C, and 204D) onto a different region on a surface of an image sensor. In some examples, the recombining element 208 comprises a plurality of pickoff mirrors (e.g., D-shaped half mirrors, semi-circular half mirrors, knife-edge prism mirrors, and/or any other mirror with an edge).

In some embodiments, as depicted, the recombining element 208 comprises a first pickoff mirror 220A, a second pickoff mirror 220B, and a third pickoff mirror 220C. In some embodiments, the first pickoff mirror 220A is mounted at a first angle, and the second pickoff mirror 220B and third pickoff mirror 220C are mounted at a second angle that is 90 degrees from the first angle. In some embodiments, the first pickoff mirror 220A and the second pickoff mirror 220B are arranged to reflect the first secondary light beam 204A onto a first region on a surface of the image sensor. In some embodiments, the first pickoff mirror 220A is arranged to reflect the second secondary light beam 204B onto a second region on a surface of the image sensor. In some embodiments, the second pickoff mirror 220B is arranged such that the second secondary light beam 204B passes beneath it. In some embodiments, the third pickoff mirror 220C is arranged to reflect the third secondary light beam 204C onto a third region on a surface of the image sensor. In some embodiments, the first pickoff mirror 220A is arranged such that the third secondary light beam 204C passes beside it. In some embodiments, the first pickoff mirror 220A and the third pickoff mirror 220C are arranged such that the fourth secondary light beam 204D pass beside and beneath them, respectively, and onto a fourth region on a surface of the image sensor. In some embodiments, recombining elements that comprise D-shaped half mirrors and/or semi-circular half mirrors provide improved flatness, enhance optical performance of imaging components, and significantly reduce production costs.

While FIG. 2 provides an example of an imaging component 200, it is noted that the scope of the present disclosure is not limited to the example shown in FIG. 2. In some examples, an imaging component may comprise one or more additional and/or alternative elements that may be structured and/or positioned differently than those in FIG. 2.

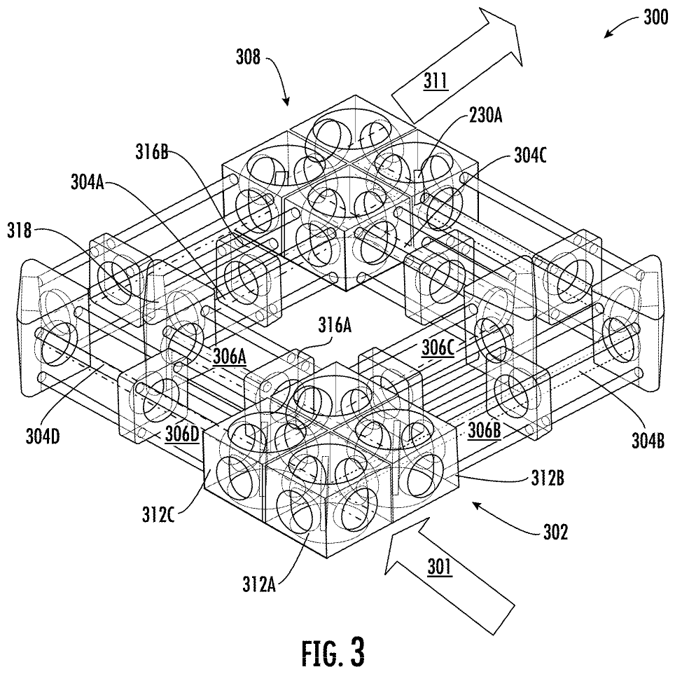

Referring now to FIG. 3, another example perspective view of an imaging component 200 is shown. In particular, as depicted, the imaging component 300 comprises a light dispersing element 302 and a recombining element 308. The imaging component 300 may be at least partially disposed within a housing and defines a body with a substantially cuboid shape. As depicted in FIG. 3, a light beam 301 may enter an aperture on a surface of the imaging component 300. The light beam 301 may be provided (e.g., generated) by an imaging apparatus (e.g., fluorescence microscope, confocal microscope, or the like) that is operatively coupled to the imaging component 300. Additionally, as depicted, the imaging component 300 defines a plurality of optical paths (e.g., passageways, channels, or the like). For example, the imaging component 300 comprises a first optical path 306A, beginning with an aperture on a surface of the imaging component 300/light dispersing element 302 through which a light beam can enter, pass through, and exit the imaging component 300 at an exit point on another surface of the imaging component 300 (e.g., adjacent an image sensor).

As shown in FIG. 3, the light beam 301 enters the aperture and is incident on (e.g., makes contact with) the light dispersing element 302. In the example shown in FIG. 3, the light dispersing element 302 is a substantially cuboid shape defining a first corner/edge of the imaging component 300. In various examples, the light dispersing element 302 is configured to split (e.g., divide) the incident light beam 301 into a plurality of secondary light beams that are each associated with a particular wavelength of light. The light dispersing element 302 may comprise a plurality of mirrors (e.g., as shown, a block or element comprising three dichroic mirrors) that is configured to split the incident light beam 301 into a plurality of secondary lights beams. In particular, the light dispersing element 302 into a first secondary light beam 304A (e.g., blue light or radiant energy), a second secondary light beam 304B (e.g., green light or radiant energy), a third secondary light beam 304C (e.g., red light or radiant energy), and a fourth secondary light beam 304D (e.g., dark red light or radiant energy).

In the example shown in FIG. 3, the light dispersing element 302 comprises a first mirror 312A, a second mirror 312B, and a third mirror 312C. In some examples, each mirror 312A, 312B, and 312C may be or comprise a dichroic mirror. In some examples, the first mirror 312A and the second mirror 312B are arranged along a first axis of the light dispersing element 302, and the first mirror 312A and the third mirror 312C are arranged along a second axis of the light dispersing element 302, where the first axis is perpendicular to the second axis. As further depicted in FIG. 3, the light dispersing element 302 directs (e.g., channels) each secondary light beam 304A, 304B, 304C, and 304D along a respective optical path within the imaging component 300. In particular, the light dispersing element 302 is configured to direct the first secondary light beam 304A along a first optical path 306A, the secondary light beam 304B along a second optical path 306B, the third secondary light beam 304C along a third optical path 306C, and the fourth secondary light beam 304D along a fourth optical path 306D. For example, the light beam 301 may first make contact with the first mirror 312A which may be configured to separate shorter wavelength beams from longer wavelength beams. Subsequently, each of the second mirror 312B and the third mirror 312C may further divide or split an incident beam into further subsets. In some embodiments, the first mirror 312A comprises a dichroic mirror with a reflection edge at 565 nanometers (nm), the second mirror 312B comprises a dichroic mirror with a reflection edge at 488 nm, and the third mirror 312C comprises a dichroic mirror with a reflection edge at 640 nm.

As illustrated in FIG. 3, each optical path 306A, 306B, 306C, and 306D defines a substantially cylindrical channel (e.g., with a 300 millimeter (mm) diameter) that is connected to a surface of the light dispersing element 302. Additionally, as shown, each optical path 306A, 306B, 306C, and 306D defines an L-shaped path (e.g., comprising two adjoining linear sections that are perpendicular to one another) disposed between the light dispersing element 302 and the recombining element 308 adjacent an exit aperture of the imaging component 300 (e.g., leading to an image sensor). Additionally, in some examples, each optical path comprises a reflective mirror that connects a first linear section to a second linear section. For example, as depicted in FIG. 3, a 45-degree reflective mirror 318 connects a first linear section of the first optical path 306A with a second linear section of the first optical path 306A. Similar or identical reflective mirrors may connect linear sections of each of the other optical paths 306B, 306C, and 306D. In the example shown in FIG. 3, the first optical path 306A and the third optical path 306C define inner channels of the imaging component 300, and the second optical path 306B and the fourth optical path 306D define outer channels of the imaging component 300. In various embodiments, each optical path 306A, 306B, 306C, and 306D comprises one or more lenses that are each configured to collimate and direct a secondary light beam passing therethrough. For example, as shown, the first optical path 306A comprises a first lens 316A and a second lens 316B that is disposed downstream in relation to the first lens 316A. The first lens 316A and the second lens 316B may each comprise relay lenses. In some embodiments, the first lens 316A is configured to collimate the first secondary light beam 304A and the second lens 316B is configured to refocus the secondary light beam 304B as it traverses the optical path 306A. Similarly, each of the second optical 306B, the third optical path 306C, and the fourth optical path 306D may comprise one or more lenses (e.g., a first lens and a second lens).

As noted above, and as depicted in FIG. 3, the imaging component 300 comprises a recombining element 308. In various embodiments, the recombining element 308 is configured to recombine a plurality of secondary light beams (e.g., secondary light beams 304A, 304B, 304C, and 304D) into a recombined light beam 311 and direct the recombined light beam 311 to an image sensor (e.g., sCMOS camera, EMCCD, or the like) of an imaging apparatus (e.g., fluorescence microscope). In some embodiments, the recombining element 308 is configured to direct each of the plurality of secondary light beams (e.g., secondary light beams 304A, 304B, 304C, and 304D) onto a different region on a surface of an image sensor. In some examples, the recombining element 308 comprises a plurality of pickoff mirrors (e.g., D-shaped half mirrors, semi-circular half mirrors, knife-edge prism mirrors, and/or any other mirror with an edge). In particular, as shown, the recombining element 308 comprises at least a first pickoff mirror 230A.

While FIG. 3 provides an example of an imaging component 300, it is noted that the scope of the present disclosure is not limited to the example shown in FIG. 3. In some examples, an imaging component may comprise one or more additional and/or alternative elements that may be structured and/or positioned differently than those in FIG. 3.

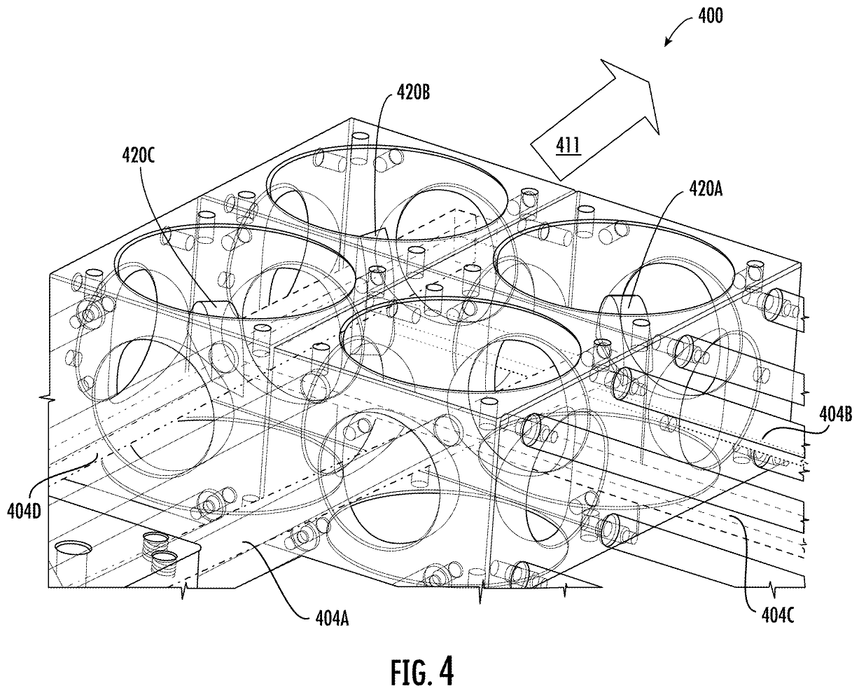

Referring now to FIG. 4, an example perspective view of a recombining element 400 is shown. The recombining element 400 may be a portion of an imaging component (e.g., imaging component 300 discussed above in connection with FIG. 3).

As depicted in FIG. 4, the recombining element 400 comprises a substantially cuboid body that is configured to recombine a plurality of secondary light beams (e.g., secondary light beams 404A, 404B, 404C, and 404D) into a recombined light beam 411 and direct the recombined light beam 411 to an image sensor (e.g., sCMOS camera, EMCCD, or the like) of an imaging apparatus (e.g., fluorescence microscope). In some embodiments, the recombining element 400 is configured to direct each of the plurality of secondary light beams (e.g., secondary light beams 404A, 404B, 404C, and 404D) onto a different region on a surface of an image sensor. As further depicted in FIG. 4, the recombining element 400 comprises a plurality of pickoff mirrors (e.g., D-shaped half mirrors, semi-circular half mirrors, knife-edge prism mirrors, and/or any other mirror with an edge). In particular, as shown, the recombining element 400 comprises at least a first pickoff mirror 420A, a second pickoff mirror 420B, and a third pickoff mirror 420C. In the example shown in FIG. 4, the first pickoff mirror 420A and the second pickoff mirror 420B are arranged along a first axis of the recombining element 400, and the second pickoff mirror 420B and the third pickoff mirror 420C are arranged along a second axis of the recombining element 400, where the first axis is perpendicular to the second axis. In some embodiments, the first pickoff mirror 420A and the third pickoff mirror 420C are mounted or arranged horizontally, and the second pickoff mirror 420B is mounted or arranged vertically.

While FIG. 4 provides an example of a recombing element 400, it is noted that the scope of the present disclosure is not limited to the example shown in FIG. 4. In some examples, a recombining element 400 may comprise one or more additional and/or alternative elements that may be structured and/or positioned differently than those in FIG. 4.

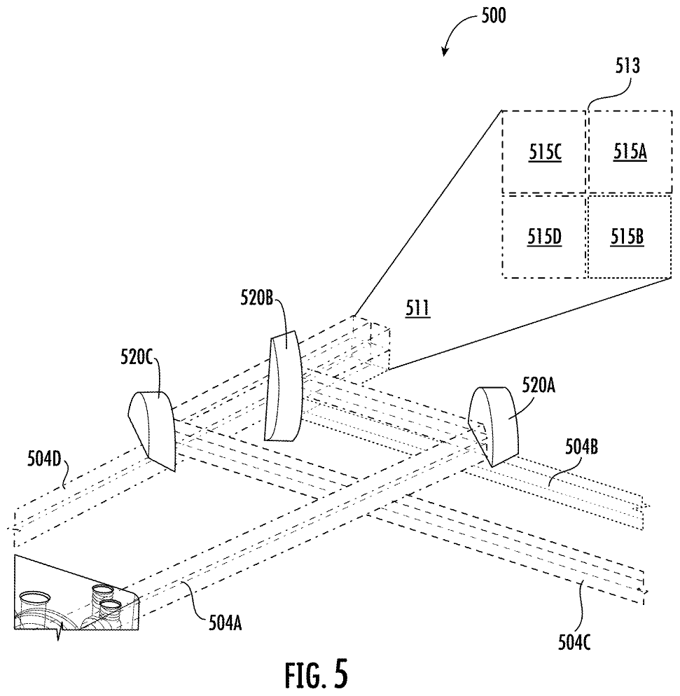

Referring now to FIG. 5, an example perspective view of a portion of a recombining element 500 is shown. The recombining element 500 may be a portion of an imaging component (e.g., imaging component 300 discussed above in connection with FIG. 3). The recombining element 500 may be similar or identical to the recombining element 400 discussed above in relation to FIG. 4.

In various embodiments, the recombining element 500 is configured to recombine a plurality of secondary light beams (e.g., secondary light beams 504A, 504B, 504C, and 504D) into a recombined light beam 511 and direct the recombined light beam 511 to an image sensor 513 (e.g., sCMOS camera, EMCCD, or the like) of an imaging apparatus (e.g., fluorescence microscope). In various examples, the recombining element 500 comprises a plurality of pickoff mirrors (e.g., D-shaped half mirrors, semi-circular half mirrors, knife-edge prism mirrors, and/or any other mirror with an edge). As depicted in FIG. 5, the recombining element 500 comprises a first pickoff mirror 520A, a second pickoff mirror 520B, and a third pickoff mirror 520C. In some embodiments, the first pickoff mirror 520A and third pickoff mirror 520C are mounted at a first angle (e.g., horizontally), and the second pickoff mirror 520B is mounted at a second angle (e.g., vertically) that is 90 degrees from the first angle. In the example shown in FIG. 5, the first pickoff mirror 520A and the second pickoff mirror 520B are arranged along a first axis of the recombining element 500, and the second pickoff mirror 520B and the third pickoff mirror 520C are arranged along a second axis of the recombining element 500, where the first axis is perpendicular to the second axis.

In some embodiments, the first pickoff mirror 520A and the second pickoff mirror 520B are arranged to reflect the first secondary light beam 504A onto a first region 515A on a surface of the image sensor 513. In other words, the first secondary light beam 504A is reflected by each of the first pickoff mirror 520A and the second pickoff mirror 520B. In some embodiments, the second pickoff mirror 520B is arranged to reflect the second secondary light beam 504B onto a second region 515B on a surface of the image sensor 513. In some embodiments, the first pickoff mirror 520A is arranged such that the second secondary light beam 504B passes beneath it as it travels towards the second region 515B on the surface of the image sensor 513. In some embodiments, the third pickoff mirror 520C is arranged to reflect the third secondary light beam 504C onto a third region 515C on a surface of the image sensor 513. In some embodiments, the second pickoff mirror 520B is arranged such that the third secondary light beam 504C passes beside it as it travels towards the third region 515C on the surface of the image sensor 513. In some embodiments, the second pickoff mirror 520B and the third pickoff mirror 520C are arranged such that the fourth secondary light beam 504D pass beside and beneath them, respectively, and onto a fourth region 515D on a surface of the image sensor 513.

While FIG. 5 provides an example of a portion of a recombing element 500, it is noted that the scope of the present disclosure is not limited to the example shown in FIG. 5. In some examples, a recombining element 500 may comprise one or more additional and/or alternative elements that may be structured and/or positioned differently than those in FIG. 5.

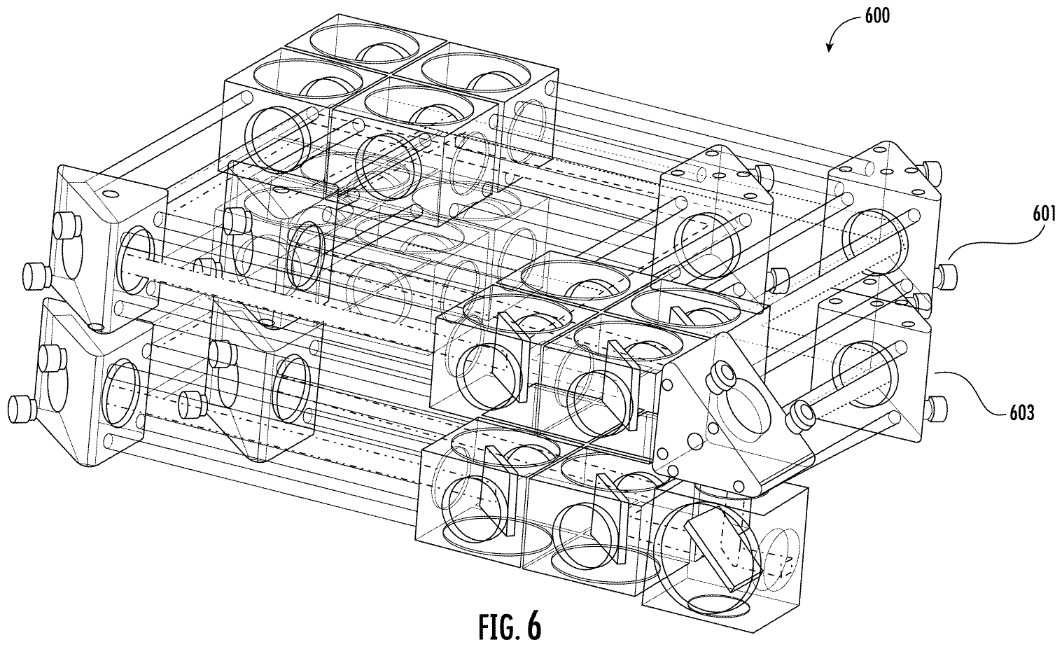

Referring now to FIG. 6, an example perspective view of a multi-color imaging system 600 is shown. A multi-color imaging system in accordance with the present disclosure may comprise two or more modular imaging components, such as the imaging component 200 described above in relation to FIG. 2. The multi-color imaging system 600 may be configured to split at least one light beam into eight secondary light beams (i.e., an eight-color splitter).

In the example shown in FIG. 6, the multi-color imaging system 600 comprises a first modular imaging component 601 and a second modular imaging component 603. As depicted in FIG. 6, the first modular imaging component 601 is disposed on/defines a top surface of the multi-color imaging system 600, and the second modular imaging component 603 is disposed on/defines a bottom surface of the multi-color imaging system 600. In other words, a bottom surface of the first modular imaging component 601 is positioned adjacent a top surface of the second modular imaging component 603. In various embodiments, the first modular imaging component 601 and the second modular imaging component 603 may be operatively coupled (e.g., fixedly attached or removably attached) to one another.

As depicted in FIG. 6, each of the first modular imaging component 601 and the second modular imaging component 603 comprises a light dispersing element that is configured to split an incident light beam into a plurality of secondary light beams, wherein each of the plurality of light beams is associated with a particular wavelength. Additionally, each of the first modular imaging component 601 and the second modular imaging component 603 comprises a plurality of lenses that are each configured to collimate and direct one of the plurality of secondary light beams along a respective optical path within the respective modular imaging component. As further depicted, each of the first modular imaging component 601 and the second modular imaging component 603 comprises a recombining element comprising a plurality of pickoff mirrors that is configured to: (i) recombine the plurality of secondary light beams into a recombined light beam, and (ii) direct the recombined light beam to an image sensor.

In some embodiments, the multi-color imaging system 600 comprises a single image sensor. In some embodiments, each of the first modular imaging component 601 and the second modular imaging component 603 may comprise a respective image sensor such that each modular imaging component 601 and 603 can acquire a four-color image. By utilizing two image sensors, the multi-color imaging system 600 can preserve a single field of view as a four-color splitter and would require fewer optical elements.

Alternatively, the multi-color imaging system 600 may comprise a recombining element with four pickoff mirrors that is configured to direct/place eight images onto a single image sensor.

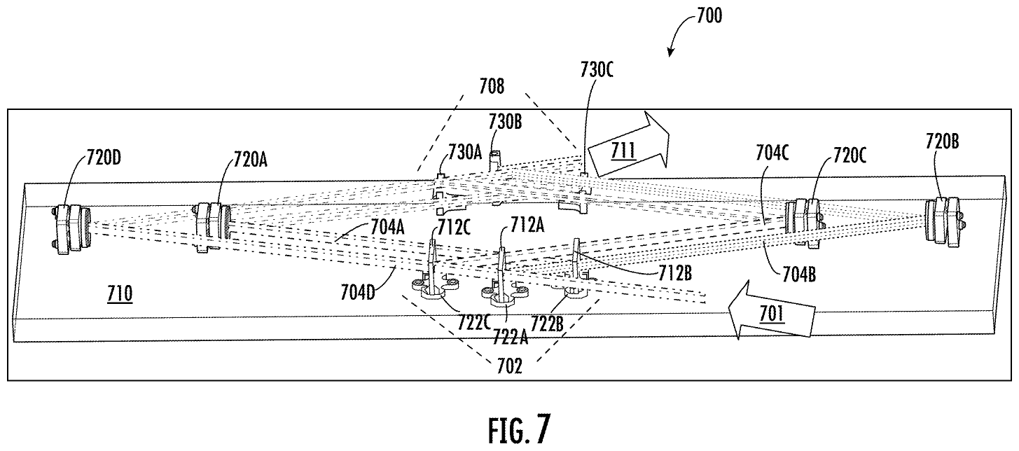

Referring now to FIG. 7, an example perspective view of an imaging component 700 in accordance with various embodiments of the present disclosure is provided. In particular, as depicted, the imaging component 700 comprises a first plurality (e.g., set, group) of mirrors 712A, 712B, and 712C which define a light dispersing portion 702 of the imaging component 700 and a second plurality of mirrors 730A, 730B, 730C which define a recombining portion 708 of the imaging component 700. The term dispersing portion may refer to an area (e.g., location, space, or the like) within an imaging component where a light beam is divided into a plurality of secondary light beams. In some examples, a dispersing portion can comprise a set of mirrors or other optical elements. Similarly, the term recombining portion may refer to an area (e.g., location, space, or the like) within an imaging component where a plurality of secondary light beams is recombined. In some examples, as described herein, a recombining portion can refer to a set of mirrors and/or other optical elements. In some implementations, the imaging component 700 may be at least partially disposed within a housing. As depicted in FIG. 7, a light beam 701 may enter an aperture on a surface of the imaging component 700. The light beam 701 may be provided (e.g., generated) by an imaging apparatus (e.g., fluorescence microscope, confocal microscope, or the like) that is operatively coupled to the imaging component 700. Additionally, as depicted, the imaging component 700 defines at least one optical path (e.g., passageways, channels, or the like) through which the light beam can enter, pass through, and exit the imaging component 700 at an exit point on another surface of the imaging component 700 (e.g., adjacent an image sensor).

As shown in FIG. 7, the light beam 701 enters the aperture and is incident on (e.g., makes contact with) a first mirror 712A, a second mirror 712B, and a third mirror 712C of the light dispersing portion 702. The plurality of mirrors 712A, 712B, and 712C are configured to split (e.g., divide) the incident light beam 701 into a plurality of secondary light beams that are each associated with a particular wavelength of light. Each of the plurality of mirrors 712A, 712B, and 712C can be a dichroic mirror or other type of mirror. As further depicted, each of the plurality of mirrors 712A, 712B, and 712C is mounted on a substrate 710 (e.g., breadboard, membrane, or the like) that defines a bottom/horizontal surface of the imaging component 700. For example, each of the plurality of mirrors 712A, 712B, and 712C can be fixedly or removably attached to the top surface of the substrate 710. In other examples, as shown, each of the plurality of mirrors 712A, 712B, and 712C (e.g., dichroic mirror) may be secured to the substrate 710 via a respective supporting element 722A, 722B, and 722C (e.g., attachment, mount, base, frame, or the like). Additionally, each of the plurality of mirrors 712A, 712B, and 712C can by positioned at an angle that is substantially perpendicular to the horizontal surface of the substrate 710 or, for example, between 0 degrees and 45 degrees. By way of example, at least one of the plurality of mirrors may be positioned 14 degrees perpendicular to the horizontal surface of the substrate 710. In various examples, each of the plurality of mirrors 712A, 712B, and 712C can be positioned at the same angle or at different angles. Mounting each of the plurality of mirrors 712A, 712B, and 712C at an angle between 0 and 45 degrees relative to the horizontal surface of the substrate further reduces distortion of images generated by the imaging component 700.

As shown, the plurality of mirrors 712A, 712B, and 712C are configured to split the light beam 701 into a first secondary light beam 704A (e.g., blue light or radiant energy), a second secondary light beam 704B (e.g., green light or radiant energy), a third secondary light beam 704C (e.g., red light or radiant energy), and a fourth secondary light beam 704D (e.g., dark red light or radiant energy). Additionally, the first mirror 712A and the second mirror 712B are arranged along a first axis, and the first mirror 712A and the third mirror 712C are arranged along a second axis, where the first axis is perpendicular to the second axis. In some examples, the first axis and the second axis are arranged at an angle that is determined by a respective angle of each of a plurality of pickoff mirrors (e.g., dichroic mirrors) of a recombining portion 708 of the imaging component 700. The imaging component 700 is configured to direct (e.g., channel) each secondary light beam 704A, 704B, 704C, and 704D along a respective optical path within the imaging component 700. For example, the light beam 701 may first make contact with the first mirror 712A which may be configured to separate shorter wavelength beams from longer wavelength beams. Subsequently, each of the second mirror 712B and the third mirror 712C may further divide or split an incident beam into further subsets. In some embodiments, the first mirror 712A comprises a dichroic mirror with a reflection edge at 565 nanometers (nm), the second mirror 712B comprises a dichroic mirror with a reflection edge at 488 nm, and the third mirror 712C comprises a dichroic mirror with a reflection edge at 640 nm. Each secondary light beam 704A, 704B, 704C, 704D makes contact with one or more optical components (e.g., reflective mirrors, lenses) as it travels along a respective path within the imaging component 700 that are each configured to collimate and direct a secondary light beam. As depicted, each secondary light beam 704A, 704B, 704C, 704D makes contact with a corresponding one of a plurality of lenses (e.g., reflective lenses) 720A, 720B, 720C, and 720D.

As further depicted in FIG. 7, the imaging component 700 comprises a plurality of pickoff mirrors 730A, 730B, 730C defining a recombining portion 708 of the imaging component 700. In some embodiments, the first pickoff mirror 730A is mounted at a first angle, and the second pickoff mirror 730B and third pickoff mirror 730C are mounted at a second angle that is different from the first angle. In various embodiments, the plurality of pickoff mirrors 730A, 730B, 730C is configured to recombine the plurality of secondary light beams (e.g., secondary light beams 704A, 704B, 704C, and 704D) into a recombined light beam 711 and direct the recombined light beam 711 to an image sensor (e.g., sCMOS camera, EMCCD, or the like) of an imaging apparatus (e.g., fluorescence microscope). In some embodiments, the plurality of pickoff mirrors 730A, 730B, 730C is configured to direct each of the plurality of secondary light beams (e.g., secondary light beams 704A, 704B, 704C, and 704D) onto a different region on a surface of an image sensor. In some examples, the plurality of pickoff mirrors 730A, 730B, 730C can be or comprise D-shaped half mirrors, semi-circular half mirrors, knife-edge prism mirrors, and/or any other mirror with an edge. In some implementations, the optical axis of the first pickoff mirror 730A and the optical axis of the second pickoff mirror 730B are perpendicular.

In some embodiments, the first pickoff mirror 730A and the second pickoff mirror 730B are arranged to reflect the first secondary light beam 704A onto a first region on a surface of the image sensor. In some embodiments, the first pickoff mirror 730A is arranged to reflect the second secondary light beam 704B onto a second region on a surface of the image sensor. In some embodiments, the second pickoff mirror 730B is arranged such that the second secondary light beam 704B passes beneath it. In some embodiments, the third pickoff mirror 730C is arranged to reflect the third secondary light beam 704C onto a third region on a surface of the image sensor. In some embodiments, the first pickoff mirror 730A is arranged such that the third secondary light beam 704C passes beside it. In some embodiments, the first pickoff mirror 730A and the third pickoff mirror 730C are arranged such that the fourth secondary light beam 704D pass beside and beneath them, respectively, and onto a fourth region on a surface of the image sensor.

While FIG. 7 provides an example of an imaging component 700, it is noted that the scope of the present disclosure is not limited to the example shown in FIG. 7. In some examples, an imaging component may comprise one or more additional and/or alternative elements that may be structured and/or positioned differently than those in FIG. 7.

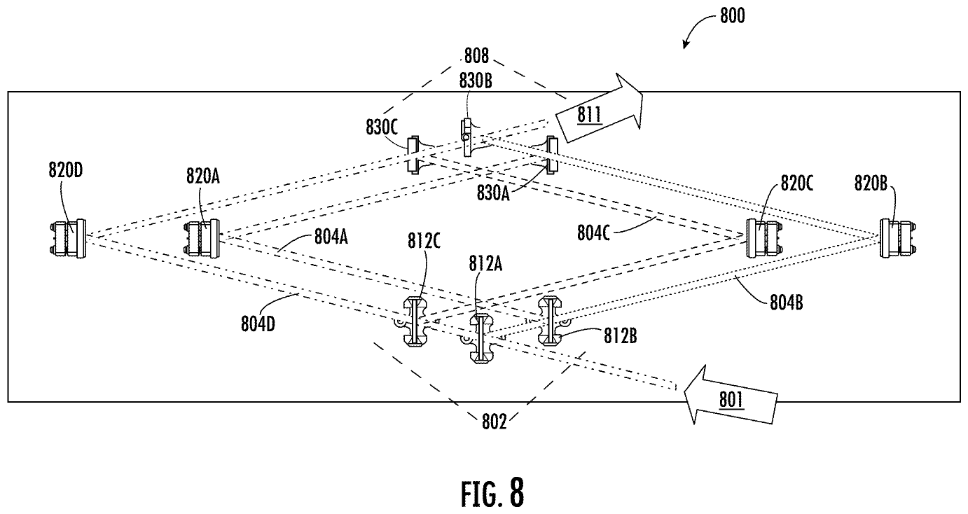

Referring now to FIG. 8, another example perspective view of an imaging component 800 in accordance with various embodiments of the present disclosure is provided. The imaging component 800 may be similar or identical to the imaging component discussed above in connection with FIG. 7. Similarly, the imaging component 800 comprises a first plurality of mirrors 812A, 812B, and 812C defining a light dispersing portion 802 and a second plurality of mirrors 830A, 830B, 830C defining a recombining portion 808. As depicted in FIG. 8, a light beam 801 may enter an aperture on a surface of the imaging component 800, travel along at least one optical path (e.g., passageways, channels, or the like), and exit the imaging component 800 at an exit point on another surface of the imaging component 800 (e.g., adjacent an image sensor).

As shown in FIG. 8, the light beam 801 enters the aperture and is incident on (e.g., makes contact with) the first mirror 812A, the second mirror 812B, and the third mirror 812C. The plurality of mirrors 812A, 812B, and 812C are configured to split (e.g., divide) the incident light beam 801 into a plurality of secondary light beams that are each associated with a particular wavelength of light. Each of the plurality of mirrors 812A, 812B, and 812C can be a dichroic mirror or other type of mirror. Each of the plurality of mirrors 812A, 812B, and 812C may be mounted on a substrate as described above in connection with FIG. 7. Each of the plurality of mirrors 812A, 812B, and 812C can be positioned at an angle that is substantially perpendicular to the horizontal surface of the substrate or between 0 degrees and 45 degrees.

As shown, the plurality of mirrors 812A, 812B, and 812C are configured to split the light beam 801 into a first secondary light beam 804A (e.g., blue light or radiant energy), a second secondary light beam 804B (e.g., green light or radiant energy), a third secondary light beam 804C (e.g., red light or radiant energy), and a fourth secondary light beam 804D (e.g., dark red light or radiant energy). Additionally, the first mirror 812A and the second mirror 812B are arranged along a first axis, and the first mirror 812A and the third mirror 812C are arranged along a second axis, where the first axis is perpendicular to the second axis. The imaging component 800 is configured to direct (e.g., channel) each secondary light beam 804A, 804B, 804C, and 804D along a respective optical path within the imaging component 800. For example, the light beam 801 makes contact with the first mirror 812A which may be configured to separate shorter wavelength beams from longer wavelength beams. Subsequently, each of the second mirror 812B and the third mirror 812C may further divide or split an incident beam into further subsets. Each secondary light beam 804A, 804B, 804C, 804D makes contact with one or more optical components (e.g., reflective mirrors, lenses) as it travels along a respective path within the imaging component 800 that are each configured to collimate and direct a secondary light beam passing therethrough. As depicted, each secondary light beam 804A, 804B, 804C, 804D makes contact with a corresponding one of a plurality of lenses (e.g., reflective lenses) 820A, 820B, 820C, and 820D.

As noted above, the imaging component 800 comprises a plurality of pickoff mirrors 830A, 830B, 830C defining a recombining portion 808. The plurality of pickoff mirrors 830A, 830B, 830C is configured to recombine the plurality of secondary light beams (e.g., secondary light beams 804A, 804B, 804C, and 804D) into a recombined light beam 811 and direct the recombined light beam 811 to an image sensor (e.g., sCMOS camera, EMCCD, or the like) of an imaging apparatus (e.g., fluorescence microscope). In some embodiments, the plurality of pickoff mirrors 830A, 830B, 830C is configured to direct each of the plurality of secondary light beams (e.g., secondary light beams 804A, 804B, 804C, and 804D) onto a different region on a surface of an image sensor.

While FIG. 8 provides an example of an imaging component 800, it is noted that the scope of the present disclosure is not limited to the example shown in FIG. 8. In some examples, an imaging component may comprise one or more additional and/or alternative elements that may be structured and/or positioned differently than those in FIG. 8.

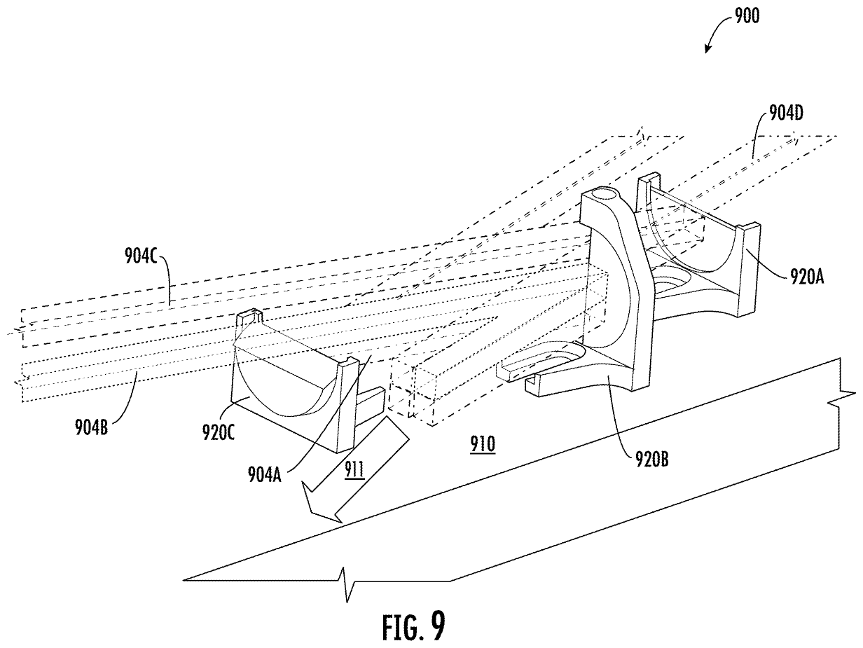

Referring now to FIG. 9, an example perspective view of a recombining portion 900 is shown. The recombining portion 900 may be a portion of an imaging component (e.g., imaging component 700 discussed above in connection with FIG. 7).

In various embodiments, the recombining portion 900 is configured to recombine a plurality of secondary light beams (e.g., secondary light beams 904A, 904B, 904C, and 904D) into a recombined light beam 911 and direct the recombined light beam 911 to an image sensor (e.g., sCMOS camera, EMCCD, or the like) of an imaging apparatus (e.g., fluorescence microscope). As shown, the recombining portion 900 comprises a first pickoff mirror 920A, a second pickoff mirror 920B, and a third pickoff mirror 920C positioned on a substrate 910 of the imaging component. In some embodiments, the first pickoff mirror 920A and third pickoff mirror 920C are mounted/positioned at a first angle (e.g., horizontally), and the second pickoff mirror 920B is mounted at a second angle (e.g., vertically).

In some embodiments, the first pickoff mirror 920A and the second pickoff mirror 920B are arranged to reflect the first secondary light beam 904A onto a first region on a surface of the image sensor. In other words, the first secondary light beam 904A is reflected by each of the first pickoff mirror 920A and the second pickoff mirror 920B. In some embodiments, the second pickoff mirror 920B is arranged to reflect the second secondary light beam 904B onto a second region on a surface of the image sensor. In some embodiments, the first pickoff mirror 920A is arranged such that the second secondary light beam 904B passes beside/above it and reflects off the second pickoff mirror 920B as it travels towards the second region on the surface of the image sensor. In some embodiments, the first pickoff mirror 920A and the second pickoff mirror 920B are arranged such that the third secondary light beam 904C reflects off the first pickoff mirror 920A and beside the second pickoff mirror 920B as it travels towards a third region on a surface of the image sensor. In some embodiments, the first pickoff mirror 920A and the second pickoff mirror 920B are arranged such that the fourth secondary light beam 904D passes above the first pickoff mirror 920A and beside the second pickoff mirror 920B as it travels towards a fourth region on the surface of the image sensor.

While FIG. 9 provides an example of a recombining portion 900, it is noted that the scope of the present disclosure is not limited to the example shown in FIG. 9. In some examples, a recombining portion 900 may comprise one or more additional and/or alternative elements that may be structured and/or positioned differently than those in FIG. 9.

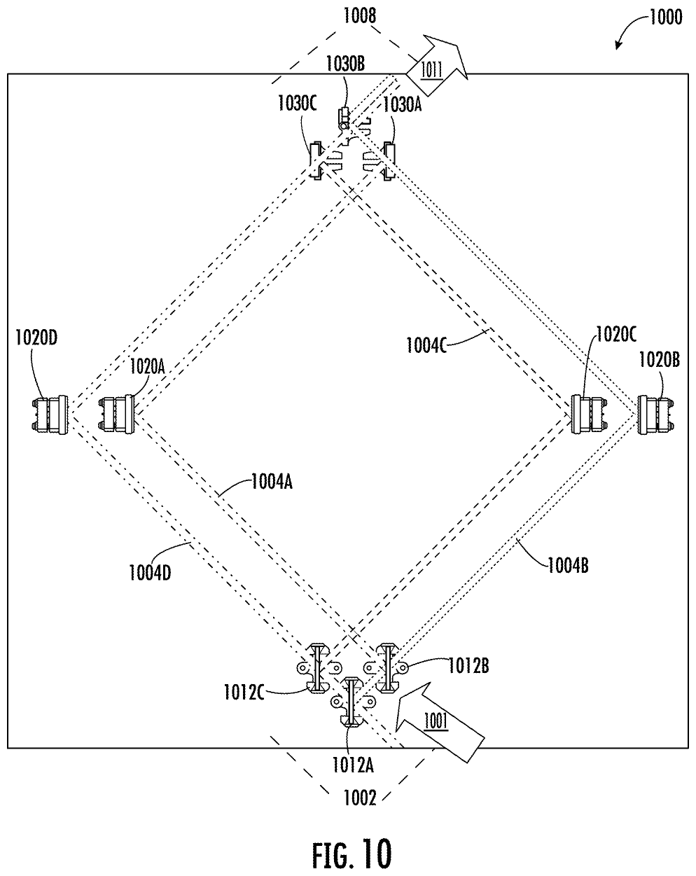

Referring now to FIG. 10, a top view of an imaging component 1000 in accordance with various embodiments of the present disclosure is provided. The imaging component 1000 may be similar or identical to the imaging component discussed above in connection with FIG. 8. Similarly, the imaging component 1000 comprises a first plurality of mirrors 1012A, 1012B, and 1012C defining a light dispersing portion 1002 of the imaging component 1000 and a second plurality of mirrors 1030A, 1030B, 1030C defining a recombining portion 1008 of the imaging component 1000. As depicted in FIG. 10, a light beam 1001 may enter an aperture on a surface of the imaging component 1000, travel along at least one optical path (e.g., passageways, channels, or the like), and exit the imaging component 1000 at an exit point on another surface of the imaging component 1000.

As shown in FIG. 10, the light beam 1001 enters the aperture and is incident on (e.g., makes contact with) the first mirror 1012A, the second mirror 1012B, and the third mirror 1012C. The plurality of mirrors 1012A, 1012B, and 1012C are configured to split (e.g., divide) the incident light beam 1001 into a plurality of secondary light beams that are each associated with a particular wavelength of light. Each of the plurality of mirrors 1012A, 1012B, and 1012C can be a dichroic mirror or other type of mirror. In some implementations, each of the plurality of mirrors 1012A, 1012B, and 1012C may be mounted on a substrate.

As shown, the plurality of mirrors 1012A, 1012B, and 1012C are configured to split the light beam 1001 into a first secondary light beam 1004A (e.g., blue light or radiant energy), a second secondary light beam 1004B (e.g., green light or radiant energy), a third secondary light beam 1004C (e.g., red light or radiant energy), and a fourth secondary light beam 1004D (e.g., dark red light or radiant energy). Additionally, the first mirror 1012A and the second mirror 1012B are arranged along a first axis, and the first mirror 1012A and the third mirror 1012C are arranged along a second axis, where the first axis is perpendicular to the second axis. The imaging component 1000 is configured to direct (e.g., channel) each secondary light beam 1004A, 1004B, 1004C, and 1004D along a respective optical path within the imaging component 1000. For example, the light beam 1001 makes contact with the first mirror 1012A which may be configured to separate shorter wavelength beams from longer wavelength beams. Subsequently, each of the second mirror 1012B and the third mirror 1012C may further divide or split an incident beam into further subsets. As depicted, each secondary light beam 1004A, 1004B, 1004C, 1004D makes contact with a corresponding one of a plurality of lenses (e.g., reflective lenses) 1020A, 1020B, 1020C, and 1020D as it travels through the imaging component 1000.

As noted above, the imaging component 1000 comprises a plurality of pickoff mirrors 1030A, 1030B, 1030C defining a recombining portion 1008. The plurality of pickoff mirrors 1030A, 1030B, 1030C is configured to recombine the plurality of secondary light beams (e.g., secondary light beams 1004A, 1004B, 1004C, and 1004D) into a recombined light beam 1011 and direct the recombined light beam 1011 to an image sensor of an imaging apparatus. In some embodiments, the plurality of pickoff mirrors 1030A, 1030B, 1030C is configured to direct each of the plurality of secondary light beams (e.g., secondary light beams 1004A, 1004B, 1004C, and 1004D) onto a different region on a surface of an image sensor.

While FIG. 10 provides an example of an imaging component 1000, it is noted that the scope of the present disclosure is not limited to the example shown in FIG. 10. In some examples, an imaging component may comprise one or more additional and/or alternative elements that may be structured and/or positioned differently than those in FIG. 10.

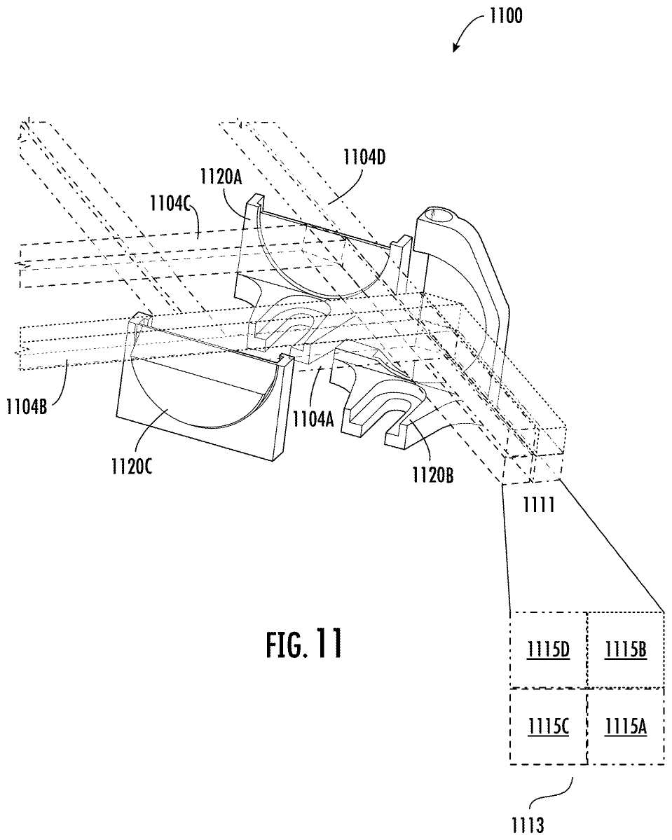

Referring now to FIG. 11, an example perspective view of a recombining portion 1100 of an imaging component is shown (e.g., imaging component 1000 discussed above in connection with FIG. 1000).

In various embodiments, the recombining portion 1100 is configured to recombine a plurality of secondary light beams (e.g., secondary light beams 1104A, 1104B, 1104C, and 1104D) into a recombined light beam 1111 and direct the recombined light beam 1111 to an image sensor 1113 (e.g., sCMOS camera, EMCCD, or the like) of an imaging apparatus (e.g., fluorescence microscope). As shown, the recombining portion 1100 comprises a first pickoff mirror 1120A, a second pickoff mirror 1120B, and a third pickoff mirror 1120C positioned on a substrate of the imaging component. In some embodiments, the first pickoff mirror 1120A and third pickoff mirror 1120C are mounted/positioned at a first angle (e.g., horizontally), and the second pickoff mirror 1120B is mounted at a second angle (e.g., vertically).

In some embodiments, the third pickoff mirror 1120C and the second pickoff mirror 1120B are arranged to reflect the first secondary light beam 1104A onto a first region 1115A on a surface of the image sensor 1113. In other words, the first secondary light beam 1104A is reflected by each of the third pickoff mirror 1120C and the second pickoff mirror 1120B. In some embodiments, the second pickoff mirror 1120B is arranged to reflect the second secondary light beam 1104B onto a second region 1115B on a surface of the image sensor 1113. In some embodiments, the third pickoff mirror 1120C is arranged such that the second secondary light beam 1104B passes beside/above it and to the second pickoff mirror 1120B as it travels towards the second region 1115B on the surface of the image sensor 1113. In some embodiments, the third secondary light beam 1104C reflects off the first pickoff mirror 1120A and the third pickoff mirror 1120C as it travels towards a third region 1115C on a surface of the image sensor 1113. In some embodiments, the first pickoff mirror 1120A and the second pickoff mirror 1120B are arranged such that the fourth secondary light beam 1104D passes above the first pickoff mirror 1120A to the second pickoff mirror 1120B as it travels towards a fourth region 1115D on the surface of the image sensor 1113.

While FIG. 11 provides an example of a recombing portion 1100, it is noted that the scope of the present disclosure is not limited to the example shown in FIG. 11. In some examples, a recombining portion 1100 may comprise one or more additional and/or alternative elements that may be structured and/or positioned differently than those in FIG. 11.

### Example Computing Device

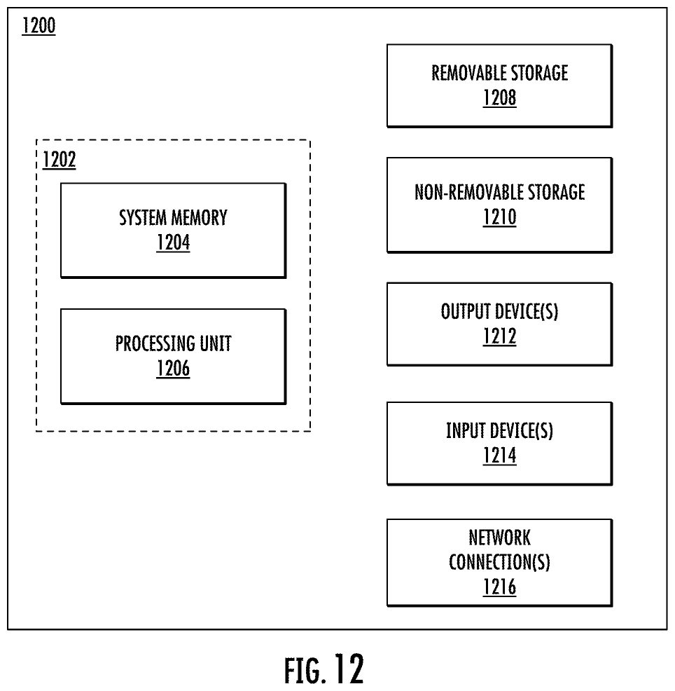

It should be appreciated that the logical operations described herein with respect to the various figures may be implemented (1) as a sequence of computer implemented acts or program modules (i.e., software) running on a computing device (e.g., the computing device described in FIG. 12), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 12, an example computing device 1200 upon which embodiments of the invention may be implemented is illustrated. This disclosure contemplates that the controller(s) for operating the flexure elements and/or imaging apparatus can be implemented using computing device 1200. It should be understood that the example computing device 1200 is only one example of a suitable computing environment upon which embodiments of the invention may be implemented. Optionally, the computing device 1200 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 1200 typically includes at least one processing unit 1206 and system memory 1204. Depending on the exact configuration and type of computing device, system memory 1204 may be volatile (such as random access memory (RAM)), non-volatile (such as read-only memory (ROM), flash memory, etc.), or some combination of the two. This most basic configuration is illustrated in FIG. 7 by dashed line 1202. The processing unit 1206 may be a standard programmable processor that performs arithmetic and logic operations necessary for operation of the computing device 1200. The computing device 1200 may also include a bus or other communication mechanism for communicating information among various components of the computing device 1200.

Computing device 1200 may have additional features/functionality. For example, computing device 1200 may include additional storage such as removable storage 1208 and non-removable storage 1210 including, but not limited to, magnetic or optical disks or tapes. Computing device 1200 may also contain network connection(s) 1216 that allow the device to communicate with other devices. Computing device 1200 may also have input device(s) 1214 such as a keyboard, mouse, touch screen, etc. Output device(s) 1212 such as a display, speakers, printer, etc. may also be included. The additional devices may be connected to the bus in order to facilitate communication of data among the components of the computing device 1200. All these devices are well known in the art and need not be discussed at length here.

The processing unit 1206 may be configured to execute program code encoded in tangible, computer-readable media. Tangible, computer-readable media refers to any media that is capable of providing data that causes the computing device 1200 (i.e., a machine) to operate in a particular fashion. Various computer-readable media may be utilized to provide instructions to the processing unit 1206 for execution. Example tangible, computer-readable media may include, but is not limited to, volatile media, non-volatile media, removable media and non-removable media implemented in any method or technology for storage of information such as computer readable instructions, data structures, program modules or other data. System memory 1204, removable storage 1208, and non-removable storage 1210 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1206 may execute program code stored in the system memory 1204. For example, the bus may carry data to the system memory 1204, from which the processing unit 1206 receives and executes instructions. The data received by the system memory 1204 may optionally be stored on the removable storage 1208 or the non-removable storage 1210 before or after execution by the processing unit 1206.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An imaging component comprising:
a light dispersing element or light dispersing portion that is configured to split an incident light beam into a plurality of secondary light beams, wherein each of the plurality of secondary light beams is associated with a particular wavelength;
a plurality of lenses that are each configured to collimate and direct one of the plurality of secondary light beams along a respective optical path within the imaging component; and
a recombining element or recombining portion, the recombining element or recombining portion comprising a plurality of pickoff mirrors that is configured to: (i) recombine the plurality of secondary light beams into a recombined light beam, and (ii) direct the recombined light beam to an image sensor.

2. The imaging component of claim 1, wherein each optical path contains a first lens to collimate a respective one of the plurality of secondary light beams and a second lens to refocus the respective one of the plurality of secondary light beams on the image sensor.

3. The imaging component of claim 1, wherein the recombining element or recombining portion is configured to direct each of the plurality of secondary light beams onto a different region on a surface of the image sensor.

4. The imaging component of claim 1, wherein the plurality of secondary light beams comprises four secondary light beams, eight secondary light beams, or sixteen secondary light beams.

5. The imaging component of claim 1, wherein the light dispersing element or light dispersing portion comprises a plurality of dichroic mirrors, wherein each of the plurality of dichroic mirrors is positioned at an angle between 0 degrees and 45 degrees relative to a horizontal surface of the imaging component.

6. (canceled)

7. The imaging component of claim 5, wherein at least one of the plurality of dichroic mirrors is positioned at a 14 degree angle relative to a horizontal surface of the imaging component.

8. (canceled)

9. The imaging component of claim 5, wherein the plurality of dichroic mirrors comprises a first dichroic mirror, a second dichroic mirror, and a third dichroic mirror.

10. The imaging component of claim 9, wherein the first dichroic mirror and the second dichroic mirror are arranged along a first axis and the first dichroic mirror and the third dichroic mirror are arranged along a second axis, the first axis being perpendicular to the second axis, wherein the first axis and the second axis are arranged at an angle that is determined by a respective angle of each of the plurality of dichroic mirrors.

11. (canceled)

12. The imaging component of claim 9, wherein, a first optical axis of the first dichroic mirror and a second optical axis of the second dichroic mirror are perpendicular.

13. The imaging component of claim 9, wherein the light dispersing element or light dispersing portion is configured to split the incident light beam such that each of the plurality of secondary light beams encounter only two of the plurality of dichroic mirrors along its respective optical path.

14. The imaging component of claim 1, wherein the plurality of pickoff mirrors comprises a first pickoff mirror, a second pickoff mirror, and a third pickoff mirror.

15. The imaging component of claim 14, wherein the first pickoff mirror is mounted at a first angle, and the second pickoff mirror and third pickoff mirror are mounted at a second angle that is 90 degrees from the first angle.

16. The imaging component of claim 15, wherein the plurality of secondary light beams comprises a first secondary light beam, a second secondary light beam, a third secondary light beam, and a fourth secondary light beam.

17. The imaging component of claim 16, wherein the first pickoff mirror and the second pickoff mirror are arranged to reflect the first secondary light beam onto a first region on a surface of the image sensor, wherein:
the first pickoff mirror is arranged to reflect the second secondary light beam onto a second region on a surface of the image sensor and such that the third secondary light beam passes beside it,
the second pickoff mirror is arranged such that the second secondary light beam passes beneath it, and
the third pickoff mirror is arranged to reflect the third secondary light beam onto a third region on a surface of the image sensor.

18. (canceled)

19. (canceled)

20. (canceled)

21. (canceled)

22. The imaging component of claim 16, wherein the first pickoff mirror and the third pickoff mirror are arranged such that the fourth secondary light beam pass beside and beneath them, respectively, and onto a fourth region on a surface of the image sensor.

23. The imaging component of claim 1, wherein each pickoff mirror comprises a semi-circular D-shaped mirror.

24. The imaging component of claim 1, wherein the imaging component is operatively coupled to or mounted adjacent an emission port of a fluorescence microscope or confocal microscope.

25. (canceled)

26. The imaging component of claim 1, wherein the image sensor comprises a complementary metal-oxide-semiconductor image sensor or electron multiplying charge couple detector.

27. A multi-color imaging system comprising:
a first modular imaging component; and
a second modular imaging component operatively coupled to the first modular imaging component, wherein each of the first modular imaging component and the second modular imaging component comprises:
a light dispersing element or light dispersing portion that is configured to split an incident light beam into a plurality of secondary light beams, wherein each of the plurality of secondary light beams is associated with a particular wavelength,
a plurality of lenses that are each configured to collimate and direct one of the plurality of secondary light beams along a respective optical path within the first or second modular imaging component, and
a recombining element or recombining portion, the recombining element or recombining portion comprising a plurality of pickoff mirrors that is configured to: (i) recombine the plurality of secondary light beams into a recombined light beam, and (ii) direct the recombined light beam to an image sensor, wherein a bottom surface of the second modular imaging component is positioned adjacent a top surface of the first modular imaging component.

28. (canceled)

29. (canceled)

30. A method for capturing multi-color images using an imaging component comprising a light dispersing element or light dispersing portion, a plurality of lenses, and a recombining element or recombining portion comprising a plurality of pickoff mirrors, the method comprising:
receiving a light beam via an aperture of the imaging component;
splitting, using the light dispersing element or light dispersing portion, the light beam into a plurality of secondary light beams, wherein each of the plurality of secondary light beams is associated with a particular wavelength;
collimating and directing, using the plurality of lenses, each of the plurality of secondary light beams along a respective optical path within the imaging component;
recombining, using the recombining element or recombining portion, the plurality of secondary light beams into a recombined light beam; and
directing the recombined light beam to an image sensor.
